(19) United States
(12) Patent Application Publication
(10) Pub. No.: US 2002/0110210 A1
(43) Pub. Date: Aug. 15, 2002

(54) Method and apparatus for adjusting timing in a digital system

(75) Inventors: Michael R. May, Austin, TX (US); Carlin D. Cabler, Austin, TX (US)

Correspondence Address: TIM MARKSION, GENERAL COUNSEL, SIGMATEL, INC, 2700 VIA FORTUNA, SUITE 500, AUSTIN, TX, 78746, US

(73) Assignee: SigmaTel, Inc.

(21) Appl. No.: 09/782,126

(22) Filed: Feb. 13, 2001

(51) Int. Cl. H04L 7/00

(52) U.S. Cl. 375/357; 375/376

(57) ABSTRACT

A method and apparatus for adjusting timing in a digital system or telecommunication system includes processing that begins by dividing a data clock by a 1^{st} value to produce a divided data clock. The processing continues by dividing an analog front-end clock by a 2^{nd} value to produce a divided analog front-end clock. The 1^{st} and 2^{nd} values are selected such that the divided data clock and the divided analog front-end clock have similar clock rates. The processing continues by comparing the phase of the divided data clock with the phase of the divided analog front-end clock to produce a phase difference. The processing continues by adjusting the analog front-end clock based on the phase difference to produce an adjusted analog front-end clock.

### RELATED PATENT APPLICATIONS

METHOD AND APPARATUS FOR PROVIDING DATA FOR SAMPLE RATE CONVERSION having an attorney docket number of SIG000063 and a filing the date the same as the present patent application; and

METHOD AND APPARATUS FOR PROVIDING DOMAIN CONVERSIONS FOR MULTIPLE CHANNELS AND APPLICATIONS THEREOF having an attorney docket number of SIG000059 and a filing the date the same as the present patent application.

### TECHNICAL FIELD OF THE INVENTION

This invention relates generally to telecommunications and more particularly to an analog front-end for use in such telecommunication systems.

### BACKGROUND OF THE INVENTION

As is known, data may be communicated from one entity (e.g. end users, computers, server, facsimile machine et cetera) to another entity via a communication infrastructure. The communication infrastructure may include a public switch telephone network (PSTN), the Internet, wireless communication system, and/or a combination thereof. Such a communication infrastructure supports many data communication protocols, which prescribe the formatting of data for accurate transmission from one entity to another. Such data communication protocols include digital subscriber line (DSL), asymmetrical digital subscriber line (ADSL), universal asymmetrical digital subscriber line (UADSL or G.Lite), high-speed digital subscriber line (HDSL), symmetrical high-speed digital subscriber lines (HDSL), asynchronous transfer mode (ATM), internet protocol (IP), et cetera.

Each of the various data transmission protocols prescribes the formatting of data into frames. Each frame may include a header section, which identifies information particular to the frame, and a data section, which carries the communication data. The data section may be divided into a plurality of data segments, time slots, carrier-frequency bins, packets, et cetera. Depending on the particular data transmission protocol, a frame of data will be transmitted in a continuous manner or in a discontinuous manner. For example, IP and ATM data transmission protocols packetize a frame of data and the packets are transmitted in a discontinuous manner. In contrast, XDSL data transmission protocols require the frames to be transmitted in a continuous manner.

For xDSL data transmission protocols, the data is processed within a modem of a given entity in the digital domain and converted to the analog domain for transmission via the communication infrastructure. Conversely, data is received via the communication infrastructure in the analog domain and converted into the digital domain for further processing. For xDSL modems, the analog to digital conversion and digital to analog conversion are done in an analog front-end. As integration of modem functionality increases, the need for more complex analog front-ends increases accordingly.

Therefore, a need exists for a method and apparatus that provides timing adjustments for an analog front end that supports multiple channels, e.g. telecommunication paths.

### BRIEF DESCRIPTION OF THE DRAWINGS

FIG. 1 illustrates a schematic block diagram of a multi-channel analog front-end in accordance with the present invention;

FIG. 2 illustrates a schematic block diagram of a sample rate conversion clocking system in accordance with the present invention;

FIG. 3 illustrates a schematic block diagram of an apparatus for adjusting timing in a digital system in accordance with the present invention;

FIG. 4 illustrates a logic diagram of a method for adjusting timing in a digital system in accordance with the present invention; and

FIG. 5 illustrates a logic diagram of an alternate method for adjusting timing in a digital system in accordance with the present invention.

### DETAILED DESCRIPTION OF A PREFERRED EMBODIMENT

Generally, the present invention provides a method and apparatus for adjusting timing in a digital system or telecommunication system. Such a method and apparatus includes processing that begins by dividing a data clock by a 1^{st} value to produce a divided data clock. The processing continues by dividing an analog front-end clock by a 2^{nd} value to produce a divided analog front-end clock. The 1^{st} and 2^{nd} values are selected such that the divided data clock and the divided analog front-end clock have similar clock rates. The processing continues by comparing the phase of the divided data clock with the phase of the divided analog front-end clock to produce a phase difference. The processing continues by adjusting the analog front-end clock based on the phase difference to produce an adjusted analog front-end clock. With such a method and apparatus, the data clock rate of multiple channels derived from the same clock source may be used to synchronize the analog front-end clock.

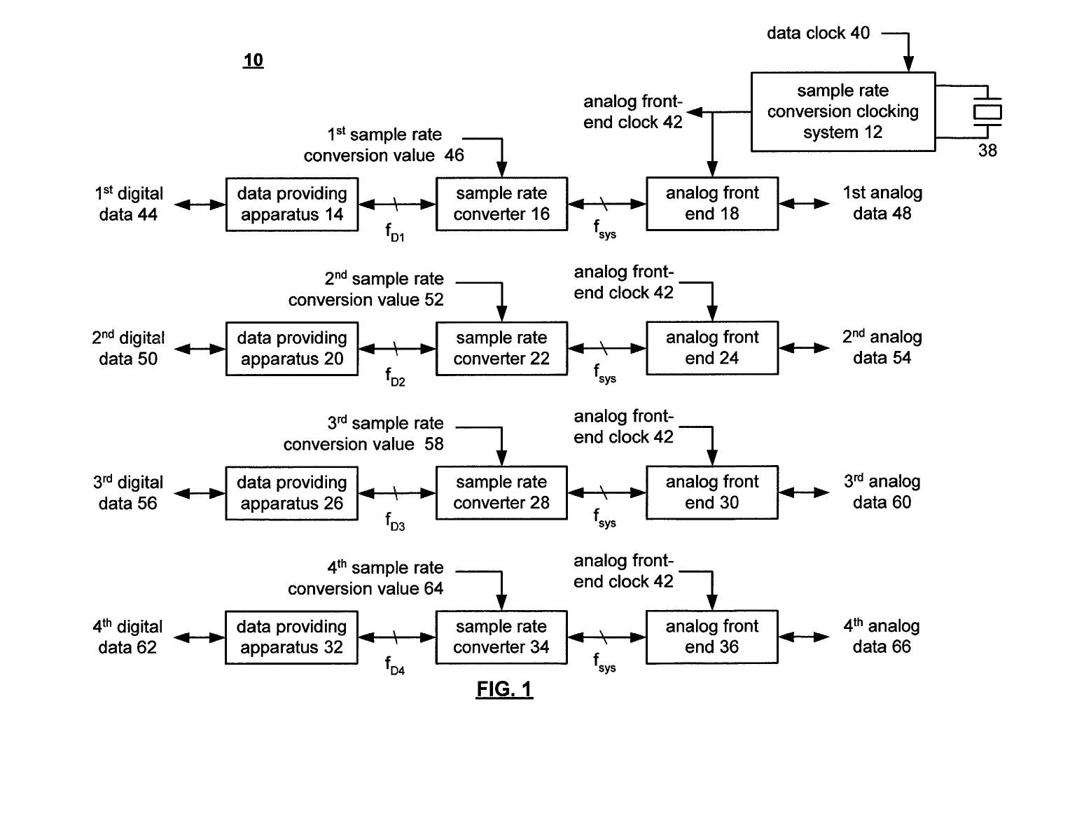

The present invention can be more fully described with reference to FIGS. 1 through 5. FIG. 1 illustrates a schematic block diagram of a multi-channel analog front-end 10. The multi-channel analog front-end 10 includes a sample rate conversion clocking system 12, a plurality of data providing apparatus's 14, 20, 26 and 32, a plurality of sample rate converters 16, 22, 28 and 34, and a plurality of front-end modules 18, 24, 30 and 36. The multi-channel analog front-end 10 supports a plurality of channels (e.g. telecommunication channels, digital system channels, computer data lines, address busses, and/or any transmission path that includes transmission line characteristics.) As such, the multi-channel analog front-end includes a data providing apparatus, sample rate converter, and analog front-end for each channel that it supports. For example, data providing apparatus 14, sample rate converter 16 and analog front-end 18 supports a 1^{st} channel. As shown, the analog front-end 18 is operably coupled to receive and transmit the bi-directional 1^{st} digital data 44 at the system clock rate (F_{SYS}) and to produce and receive 1^{st} analog data 48 respectively therefrom. Note that the sample rate conversion, the analog front-end processing, and the selection of the 1^{st} sample rate conversion value 46 is further described in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

The data providing apparatus 14 is operably coupled to receive the incoming 1^{st} data 44 at a 1^{st} data rate (F_{D1}) and provides the 1^{st} digital data 44 at the 1^{st} data rate (F_{D1}) to the sample rate converter 16. The sample rate converter 16 based on a 1^{st} sample rate conversion value 46 converts the rate of the 1^{st} data 44 from the 1^{st} data rate (F_{D1}) to a system data rate (F_{SYS}). The system data rate is based on an analog front-end clock 42. Typically, the system clock will be some integer division of the analog front-end clock 42. The determination of the 1^{st} sample rate conversion value 46 and the sample rate conversion performed based on this value is further described in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

A 2^{nd} channel is supported by the data providing apparatus 20, the sample rate converter 22, and the analog front-end 24. The data providing apparatus 20 is operably coupled to receive and transmit the 2^{nd} data 50 and provide it to, and receive it from, the sample rate converter 22 at a 2^{nd} data rate (F_{D2}). Based on a 2^{nd} sample rate conversion value 52, the sample rate converter 22 converts the data rate of the 2^{nd} digital data 50 from the 2^{nd} data rate (F_{D2}) to the system clock rate (F_{SYS}). The analog front-end 24 receives the 2^{nd} digital data 50 at the system clock rate (F_{SYS}) and produces 2^{nd} analog data 54. For incoming 2^{nd} analog data 54, the sample rate converter 22 converts the rate of the analog data to the 2^{nd} data rate (F_{D2}) A 3^{rd} channel path is supported by data providing apparatus 26, the sample rate converter 28, and the analog front-end 30. The data providing apparatus 26 is operably coupled to receive and transmit the 3^{rd} digital data 56 and to provide it to the sample rate converter 28 at a 3^{rd} data rate (F_{D3}). The sample rate converter 28 converts the rate of the 3^{rd} digital data 56 from the 3^{rd} data rate (F_{D3}) to the system clock rate (F_{SYS}) based on a 3^{rd} sample rate conversion value 58. The analog front-end 30 receives the sample rate converted 3^{rd} digital data and produces 3^{rd} analog data 60 therefrom. For incoming 3^{rd} analog data 60, the sample rate converter 28 converts the rate of the analog data to the 3^{rd} data rate (F_{D3}).

A 4^{th} channel is supported by the data providing apparatus 32, the sample rate converter 34, and the analog front-end 36. The data providing apparatus 32 is operably coupled to process 4^{th} digital data 62 and to provide or receive the 4^{th} digital data at a 4^{th} data rate (F_{D4}). The sample rate converter 34 converts the sample rate of the 4^{th} digital data 62 between the 4^{th} data rate (F_{D4}) and the system clock rate (F_{SYS}) based on a 4^{th} sample rate conversion value 64. The analog front-end 36 is operably coupled to convert the 4^{th} digital data 62 at the system clock rate to or from 4^{th} analog data 66. For incoming 4^{th} analog data 66, the sample rate converter 34 converts the rate of the analog data to the 4^{th} data rate (F_{D4}).

As one of average skill in the art will appreciate, the multi-channel analog front-end 10 may include more or less channel support devices than depicted in FIG. 1. In addition, the processing by the analog front-end 18, 24, 30 and 36 may include a digital to analog conversion process and/or an analog to digital conversion process. Such that data flow may progress from the digital data 44, 50, 56 and 62 to the analog data 48, 54, 60 and 64, or vice versa.

The sample rate conversion clocking system 12 is operably coupled to a crystal 38, a data clock 40 to produce an analog front-end clock 42. The data clock 40 may correspond to the 1^{st} data clock rate (F_{D1}), the 2^{nd} data clock rate (F_{D2}), the 3^{rd} data clock rate (F_{D3}), the 4^{th} data clock rate (F_{D4}), and/or an integer division of any of these clocks. Note that in most telecommunication systems, while the data rates for the 1^{st}, 2^{nd}, 3^{rd} and 4^{th} data 44, 50, 56 and 62 may vary, they will be based on the same backbone clock and be integer multiples or divisions of each other. As such, any one of the clocks may be utilized as the data clock 40 by the sample rate conversion clocking system 12.

The processing performed by the data providing apparatus 14, 20, 26 and 32 is further described in copending patent application entitled METHOD AND APPARATUS FOR PROVIDING DATA FOR SAMPLE RATE CONVERSION, having an attorney docket number SIG000063 and a filing date the same as the filing date for the present patent application.

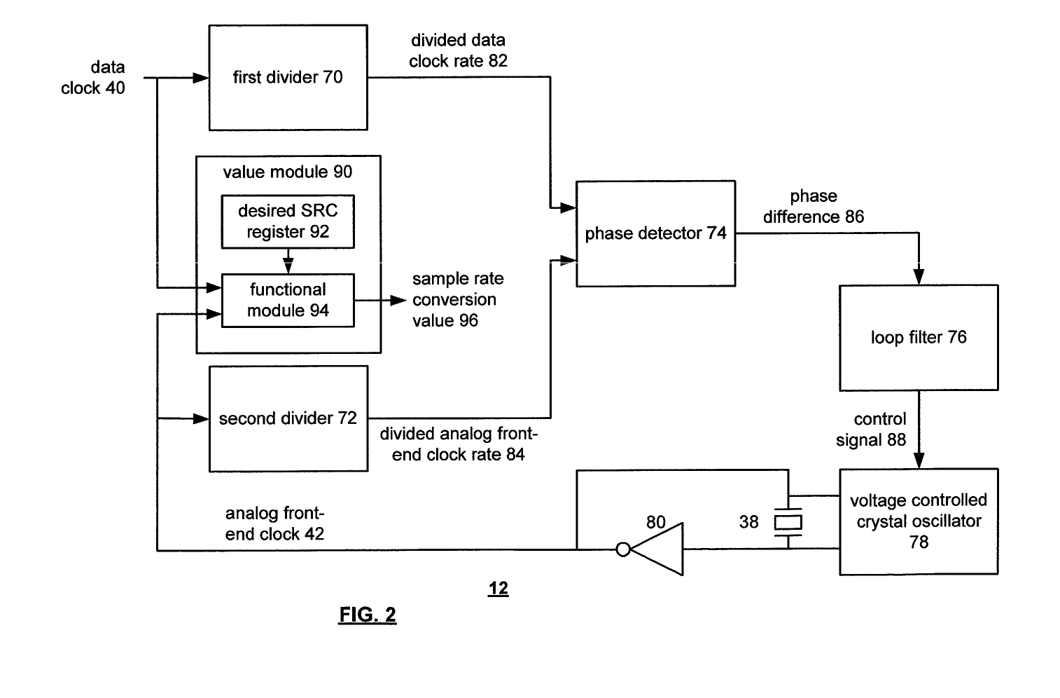

FIG. 2 illustrates a schematic block diagram of the sample rate clocking system 12. The sample rate clocking system 12 includes a 1^{st} divider 70, a 2^{nd} divider 72, a phase detector 74, a loop filter 76, a voltage controlled crystal oscillator 78, and an inverter 80. The sample rate conversion clocking system may further include a value module 90. [With respect to FIG. 1, the data providing apparatus 14, 20, 26 and 32 may include processing to perform a physical layer processing which processes data at the data clock rate to produce processed data that is provided to the sample rate converter. The physical layer processing corresponds to the particular data transmission protocol being utilized. For example, if xDSL data transmission protocol is being utilized, the physical layer receives raw data in the digital domain and adds the XDSL overhead to the data including placing the data in appropriate frames and providing appropriate frame spacing. Such processing of data is known for such particular types of data transmission protocols.]

The 1^{st} divider 70 is operably coupled to receive a data clock 40 and produce therefrom a divided data clock rate 82. The 1^{st} divider 70 may include a register for storing a 1^{st} divider value and may include a counter to perform a division function, may include a shift register for performing the divider function and/or any other logic circuitry known to divide the rate of a particular clock.

The 2^{nd} divider 72 is operably coupled to receive the analog front-end clock 42 and produce therefrom a divided analog front-end clock 84. The divider 72 may include a register for storing an analog front-end divider clock value, and circuitry for performing the clock division process, such as a counter, shift register, and/or any type of logic circuitry that decimates the rate of a data signal.

The phase detector 74 receives the divided clock rate 82 and the divided analog front-end clock rate 84 to produce a phase difference 86. The divided data clock rate 82 and the divided analog front-end clock rate 84 are of similar rates based on the particular divider values utilized by the 1^{st} divider 70 and the 2^{nd} divider 72. The phase detector 74, which may have a similar construct as a phase detector within a phase locked loop, produces the phase difference 86 to indicate a phase relationship between the divided data clock 82 and the divided analog front-end clock 84.

The loop filter 76 receives the phase difference 86 and produces a control signal 88 therefrom. The control signal is provided to a voltage control crystal oscillator 78 that regulates the oscillating of crystal 38. The inverter 80 produces a square wave representation of the oscillation of crystal 38, which is representative of the analog front-end clock 42. At the phase difference 86 between the divided data clock rate 82 and divided analog front-end clock 84 vary, the rate of the analog front-end clock 42 varies accordingly. As such, in the closed feedback route system as shown in the sample rate conversion clocking system 12, the analog front-end clock 42 is adjusted to be synchronous with the data clock 40. As one of average skill in the art will appreciate, other means of generating a pullable clock may be used in place of the voltage control crystal oscillator 78. For example, a digitally controlled oscillator may be used that adjusts the capacitance seen by the crystal 38, which causes the clock frequency to change.

The sample rate conversion clocking system 12 may further include a value module 90 that includes a desired sample rate conversion register 92 and a functional module 94. The desired sample rate conversion register 92 stores the desired sample rate conversion rate for the system. Such a sample rate conversion value may correspond to the system clock rate (F_{SYS}). Based on the desired sample rate conversion value, the data clock 40, and the analog front-end clock 42, the functional module 94 produces a sample rate conversion value 96. The sample rate conversion value will be produced for each channel path within the multi-channel analog front-end 10 of FIG. 1. The details of determining the sample rate conversion value may be found in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

As one of average skill in the art will appreciate, the sample rate conversion clocking system 12 may be a single system for the entire multi-channel analog front-end 10 or may be separate systems for each channel within the multi-channel analog front-end 10. As such, the sample rate conversion clocking system 12 ensures synchronization between the data clock rates and the analog front-end clock to minimize noise and resulting errors within the multi-channel analog front-end 10.

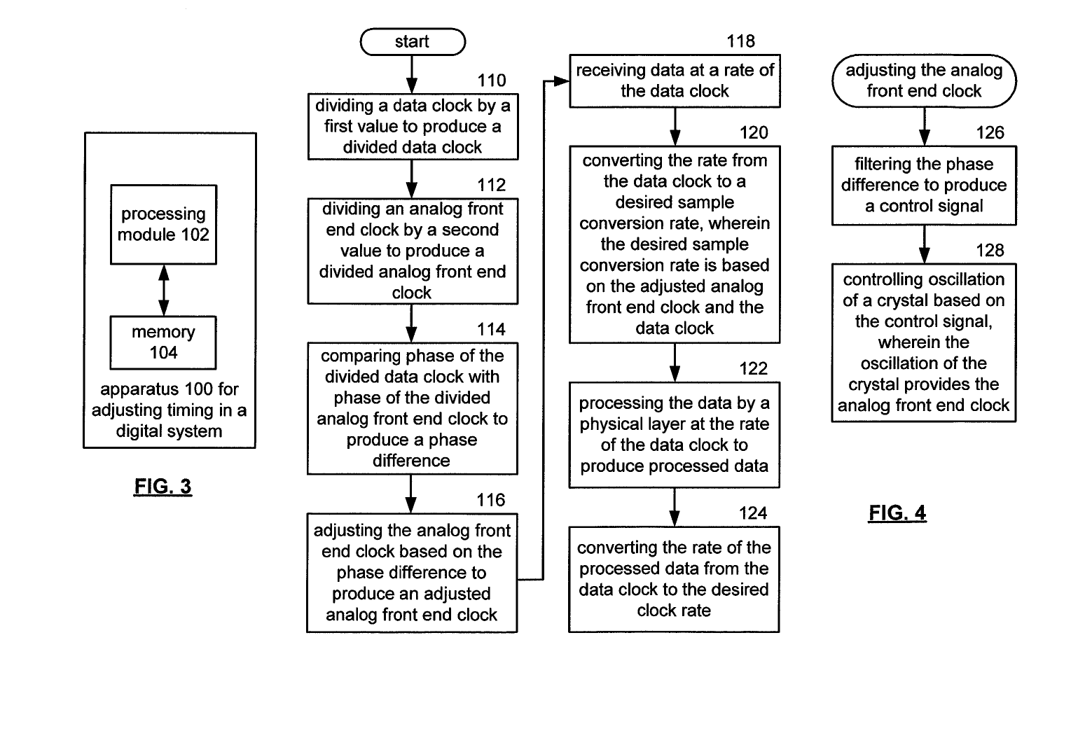

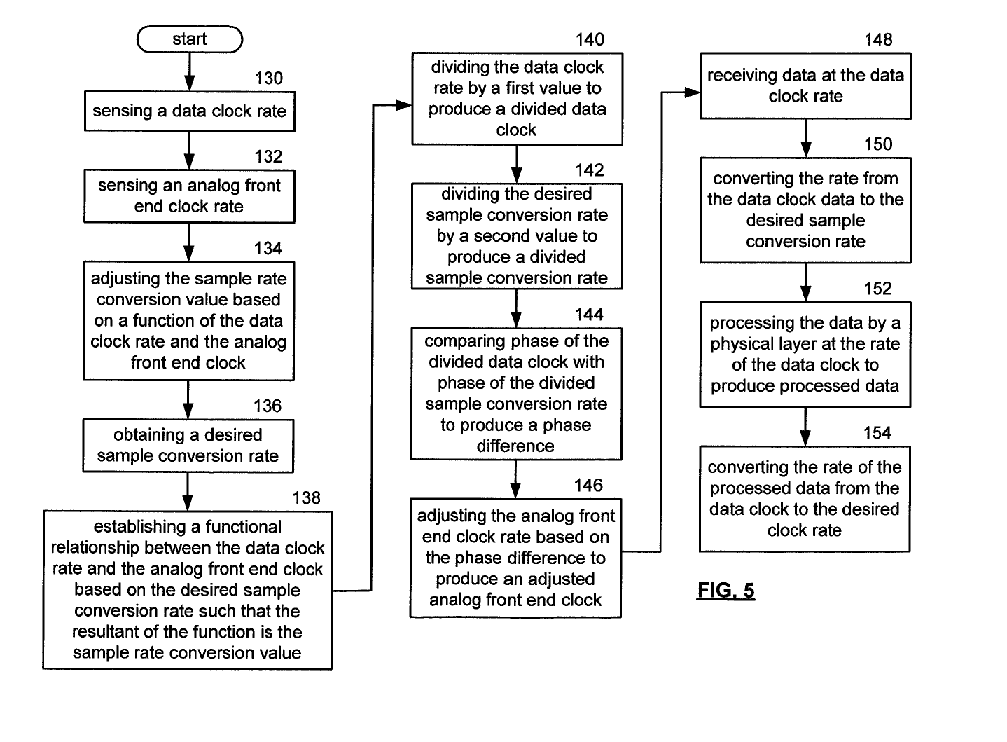

FIG. 3 illustrates a schematic block diagram of an apparatus 100 for adjusting timing in a digital system. The apparatus 100 includes a processing module 102 and memory 104. The processing module 102 may be a single memory device or a plurality of memory devices. Such a memory device may be a microprocessor, microcontroller, central processing unit, digital signal processor, state machine, logic circuitry, and/or any device that manipulates signals (analog and/or digital) based on operational instructions. Note than when the processing module implements one or more of its functions via a state machine or logic circuitry, the memory storing the corresponding operational instructions is embedded within the circuitry comprising the state machine and/or logic circuit. The memory 104 may be a single memory device or a plurality of memory devices. Such a memory device may be a read-only memory, random access memory, floppy disk memory, system memory, and/or any device that stores digital information. The operational instructions stored in memory 104 and executed by processing module 102 are illustrated in FIGS. 4 and 5.

FIG. 4 illustrates a logic diagram of a method for adjusting timing in a digital system. The process begins at Step 110 where a data clock is divided by a 1^{st} value to produce a divided data clock. The 1^{st} value may be determined based on the rate of the data, the particular data transmission protocol being supported by the multi-channel analog front-end, and the system configuration. For example, if the data rate is 70 Khz, and the analog front-end clock is 35 Mhz, the 1^{st} divider value may be too such that, the divided data clock is 35 Khz.

The process then proceeds to Step 112 where the analog front-end clock is divided by a 2^{nd} value to produce a divided analog front-end clock. Continuing with the example in the preceding paragraph, the 2^{nd} value is also based on the rate of the data, the data transport protocol, and the system configuration. In this example, the 2^{nd} value would be 1,000 such that the divided analog front-end clock is 35 Khz. The process then proceeds to Step 114 where the phase of the divided data clock is compared with the phase of the divided analog front-end clock to produce a phase difference.

The process then proceeds to Step 116 where the analog front-end clock is adjusted based on the phase difference to produce an adjusted analog front-end clock. The processing may continue at Steps 118 where data is received at the rate of the data clock. The process then proceeds to Step 120 where the rate of the data is converted from the data clock rate to a desired sample conversion rate. The desired sample conversion rate is based on the adjusted analog front-end clock and the data clock. This was previously discussed with reference to FIG. 1. The processing then continues at Step 122 where the data is processed by a physical layer at the rate of the data clock to produce processed data. As previously mentioned, the processing at the physical layer places the raw data in frames, and/or packets, and attaches the overhead associated with the particular data transmission protocol with the packetized and/or framed data. The process then proceeds to Step 124 where the rate of the processed data is converted from the data clock rate to the desired clock rate. Note that the desired clock rate corresponds to the system clock rate (F_{SYS}) of FIG. 1.

The adjusting of the analog front-end clock may be further described with reference to Steps 126 and 128. At Step 126, the phase difference is filtered to produce a control signal. The process then proceeds to Step 128 where the oscillation of a crystal is controlled based on the control signal. The oscillation of the crystal is used to produce the analog front-end clock. As such, by controlling the oscillation of the crystal, the analog front-end clock is adjusted.

FIG. 5 illustrates a logic diagram of an alternate method for adjusting timing in a digital system. The process begins at Step 130 where a data clock rate is sensed. The process then proceeds to Step 132 where an analog front-end clock rate is sensed. The process then proceeds to Step 134 where a sample rate conversion value is adjusted based on a function of the data clock rate and the analog front-end clock. The particular type of function depends on the desired sample rate conversion value. This is discussed in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

The process then proceeds to Step 136 where a desired sample conversion rate is obtained. The process then proceeds to Step 138 where a functional relationship is established between the data clock rate and the analog front-end clock based on the desired sample conversion rate such that the resultant of the function is the sample rate conversion value. The process then proceeds to Step 140 where the data clock rate is divided by a 1^{st} value to produce a divided data clock. The process then proceeds to Step 142 where the desired sample conversion rate is divided by a 2^{nd} value to produce a divided sample conversion rate. The process then proceeds to Step 144 where the phase of the divided data clock is compared with the phase of the divided sample conversion rate to produce a phase difference. The process then proceeds to Step 146 where the analog front-end clock rate is adjusted based on the phase difference to produce an adjusted analog front-end clock.

The process then proceeds to Step 148 where data is received at a data clock rate. The process then proceeds to Step 150 where the rate of the data is converted from the data clock rate to the desired sample conversion rate. The process then proceeds to Step 152 where the data is processed by a physical layer at the rate of the data clock to produce processed data. The process then proceeds to Step 154 where the rate of the processed data is converted from the data clock rate to the desired clock rate (e.g. the system clock (F_{SYS})).

The preceding discussion has presented a method and apparatus for adjusting timing in multi-channel analog front-end. By controlling the timing, noise between the circuitries that support the multi-channels is reduced. As such, a more efficient multi-channel analog front-end is obtained. As one of average skill in the art will appreciate, other embodiments may be derived from the teaching of the present invention without deviating from the scope.

What is claimed is:

1. A method for adjusting timing in a digital system, the method comprises the steps of:
dividing a data clock by a first value to produce a divided data clock;
dividing an analog front end clock by a second value to produce a divided analog front end clock;
comparing phase of the divided data clock with phase of the divided analog front end clock to produce a phase difference; and
adjusting the analog front end clock based on the phase difference to produce an adjusted analog front end clock.

2. The method of claim 1, wherein the adjusting further comprises:
filtering the phase difference to produce a control signal; and
controlling oscillation of a crystal based on the control signal, wherein the oscillation of the crystal provides the analog front end clock.

3. The method of claim 1 further comprises determining the first value based on at least one of: rate of the data, data transport protocol, and system configuration.

4. The method of claim 1 further comprises:
receiving data at a rate of the data clock; and
converting the rate from the data clock to a desired sample conversion rate, wherein the desired sample conversion rate is based on the adjusted analog front end clock and the data clock.

5. The method of claim 4 further comprises:
processing the data by a physical layer at the rate of the data clock to produce processed data; and
converting the rate of the processed data from the data clock to the desired clock rate.

6. A method for adjusting a sample rate conversion value, the method comprises the steps of:
sensing a data clock rate;
sensing an analog front end clock rate; and
adjusting the sample rate conversion value based on a function of the data clock rate and the analog front end clock.

7. The method of claim 6 further comprises:
obtaining a desired sample conversion rate; and
establishing a functional relationship between the data clock rate and the analog front end clock based on the desired sample conversion rate such that the resultant of the function is the sample rate conversion value.

8. The method of claim 7 further comprises:
dividing the data clock rate by a first value to produce a divided data clock;
dividing the desired sample conversion rate by a second value to produce a divided sample conversion rate;
comparing phase of the divided data clock with phase of the divided sample conversion rate to produce a phase difference; and
adjusting the analog front end clock rate based on the phase difference to produce an adjusted analog front end clock.

9. The method of claim 8 further comprises:
receiving data at the data clock rate; and
converting the rate from the data clock data to the desired sample conversion rate.

10. The method of claim 9 further comprises:
processing the data by a physical layer at the rate of the data clock to produce processed data; and
converting the rate of the processed data from the data clock to the desired clock rate.

11. A sample rate conversion clocking system comprises:
a first divider operably coupled to divide a data clock rate by a first value to produce a divided data clock rate;
a second divider operably coupled to divide an analog front end clock rate by a second value to produce a divided analog front end clock rate;
phase detector operably coupled to compare phase of the divided data clock rate to phase of the divided analog front end clock rate to produce a phase difference;
loop filter operably coupled to filter the phase difference to produce a control signal; and
crystal oscillator operably coupled to adjust oscillation of a crystal based on the control signal, wherein the oscillation of the crystal produces the analog front end clock rate.

12. The sample rate conversion clocking system of claim 11 further comprises:
value module operably coupled to sense the data clock rate and the analog front end clock rate, wherein the value module adjusts a sample rate conversion value based on a function of the data clock rate and the analog front end clock;
sample rate converter operably coupled to convert a rate of data from the data clock rate to a desired sample conversion rate based on the sample rate conversion value.

13. The sample rate conversion clocking system of claim 12 further comprises:
a physical layer operably coupled to process the data at the data clock rate to produce processed data, wherein the processed data is provided to the sample rate converter.

14. The sample rate conversion clocking system of claim 12, wherein the value module further comprises:
a register for storing a desired sample conversion rate; and
a functional module operably coupled to establish a functional relationship between the data clock rate and the analog front end clock rate based on the desired sample conversion rate such that the resultant of the function is the sample rate conversion value.

15. An apparatus for adjusting timing in a digital system, the apparatus comprises:
a processing module; and
memory operably coupled to the processing module, wherein the memory includes operational instructions that cause the processing module to:
divide a data clock by a first value to produce a divided data clock;
divide an analog front end clock by a second value to produce a divided analog front end clock;
compare phase of the divided data clock with phase of the divided analog front end clock to produce a phase difference; and
adjust the analog front end clock based on the phase difference to produce an adjusted analog front end clock.

16. The apparatus of claim 15, wherein the memory further comprises operational instructions that cause the processing module to adjust the analog front end clock by:
filtering the phase difference to produce a control signal; and
controlling oscillation of a crystal based on the control signal, wherein the oscillation of the crystal provides the analog front end clock.

17. The apparatus of claim 15, wherein the memory further comprises operational instructions that cause the processing module to determine the first value based on at least one of: rate of the data, data transport protocol, and system configuration.

18. The apparatus of claim 15, wherein the memory further comprises operational instructions that cause the processing module to:
receive data at a rate of the data clock; and
convert the rate from the data clock to a desired sample conversion rate, wherein the desired sample conversion rate is based on the adjusted analog front end clock and the data clock.

19. The apparatus of claim 18, wherein the memory further comprises operational instructions that cause the processing module to:
process the data by a physical layer at the rate of the data clock to produce processed data; and
convert the rate of the processed data from the data clock to the desired clock rate.

20. An apparatus for adjusting timing in a digital system, the apparatus comprises:
a processing module; and
memory operably coupled to the processing module, wherein the memory includes operational instructions that cause the processing module to:
sense a data clock rate;
sense an analog front end clock rate; and
adjust the sample rate conversion value based on a function of the data clock rate and the analog front end clock.

21. The apparatus of claim 20, wherein the memory further comprises operational instructions that cause the processing module to:
obtain a desired sample conversion rate; and
establish a functional relationship between the data clock rate and the analog front end clock based on the desired sample conversion rate such that the resultant of the function is the sample rate conversion value.

22. The apparatus of claim 21, wherein the memory further comprises operational instructions that cause the processing module to:
divide the data clock rate by a first value to produce a divided data clock;
divide the desired sample conversion rate by a second value to produce a divided sample conversion rate;
compare phase of the divided data clock with phase of the divided sample conversion rate to produce a phase difference; and
adjust the analog front end clock rate based on the phase difference to produce an adjusted analog front end clock.

23. The apparatus of claim 22, wherein the memory further comprises operational instructions that cause the processing module to:
receive data at the data clock rate; and
convert the rate from the data clock data to the desired sample conversion rate.

24. The apparatus of claim 23, wherein the memory further comprises operational instructions that cause the processing module to:
process the data by a physical layer at the rate of the data clock to produce processed data; and
convert the rate of the processed data from the data clock to the desired clock rate.
